(19) United States
(12) Patent Application Publication
(10) Pub. No.: US 2009/0162466 A1
(43) Pub. Date: Jun. 25, 2009

(54) VARIABLE MULTIPLE PARISON EXTRUSION HEAD HAVING AN ELECTRICALLY OPERATED ACTUATOR

(76) Inventors: Fabrizio Castellari, Bologna (IT); Enzo Sgargi, Castelmaggiore (IT)

Correspondence Address: STITES & HARBISON PLLC, 1199 NORTH FAIRFAX STREET, SUITE 900, ALEXANDRIA, VA, 22314, US

(21) Appl. No.: 12/296,470

(22) PCT Filed: Mar. 22, 2007
(86) PCT No.: PCT/EP2007/052763

§ 371 Date: Oct. 8, 2008

(30) Foreign Application Priority Data
Apr. 12, 2006 (IT) BO2006A000269

(51) Int. Cl. B29C 47/92; B29C 47/22

(52) U.S. Cl. 425/131.1

(57) ABSTRACT

Electrically operated actuator for modifying the thickness of the parisons during extrusion, by means of the usual means which modify the internal cross-section of the discharge mouths of the extrusion head and which are connected to a common cross-member (7) which may be guided by suitable means (107, 8) during the vertical movements, characterized in that the said cross-member is raised and lowered by means of mechanical systems which comprise at least connecting rods and cranks and which are actuated by a speed reducer (9) with limited play, which is fixed onto a support structure (102) positioned above the said cross-member (7) and moved by an electric motor (109) of suitable power, rotating in both directions and with electronic speed and phase control, for example a motor of the brushless type.

The present invention relates to machines for producing plastic containers using the technique of blow moulding, said machines being fed by an extruder for producing hot, descending, vertical tubes of thermoplastic material—so-called parisons—a portion of which is cyclically gripped inside the corresponding cavity of a mould and counter-mould unit, is separated from the continuous parison by means of a cutting operation and then, while by means of a suitable vertical relative movement of the mould/counter-mould unit and extruder, continuous operation of the latter is ensured, the same mould/counter-mould unit is transferred into a station where, inside a partially closed end of the said plastic pouches trapped inside it, corresponding nozzles are inserted so as to blow in pressurised gas which causes the said pouches to adhere closely to the cavities of the said mould and counter-mould unit, in order to form the containers with the desired dimensional and shape characteristics. Then, while the containers are retained via the mouth by the nozzles of the blowing unit, the mould and the counter-mould open and return into the parison production station, with the relative arrangement in relation to the extruder necessary for repetition of a new working cycle.

For the production of containers which in the heightwise direction have sections with a different cross-section and shape it is necessary for the wall of the parison section from which these containers are formed to have variations in thickness which are proportional to the said variations in cross-section and/or shape. The extruder die is for this purpose provided, in the region of the outlet mouths, with corresponding axial pins, which usually have a conical shape and means are envisaged for producing a relative axial displacement of pin and outlet mouth, so as to vary the internal cross-section of the said outlet mouths and these means are operated by a servo control unit which is driven by an electronic programming device which operates in accordance with a predetermined program.

This servo control unit currently uses one or more hydraulic cylinder and piston assemblies which may be synchronised during movement with rack-and-pinion systems. This solution requires periodic maintenance and checks of the cylinders both owing to the wear of the seals and because the said cylinders are in the immediate vicinity of and above the extrusion head and are therefore directly acted on by the heat emitted by this head, which heat by its very nature tends to rise. If these periodic checks are not carried out, with consequent stoppage in production, oil may leak from the said hydraulic cylinders and inevitably runs onto the extrusion head and may contaminate the parisons and all the underlying components of the blow-moulding machine, with the consequences which can be imagined.

At present an attempt has been made to find an alternative to the hydraulic cylinders and linear actuators of the screw and female-nut type, which are of the precision type and therefore have recirculating ball systems operated by an electric motor, have been proposed on the market. These actuators have a unit cost which is very high compared to the present hydraulic cylinder systems and are characterized by a limited power which limits the applications thereof or which results in the need to use several of these actuators in a same extrusion head.

The invention intends to overcome these limitations of the prior art, with an electrically operated actuator as per the accompanying Claim 1, which acts on the moving part which regulates the internal cross-section of the outlet mouths of a multiple extrusion head and which preferably is guided vertically by special means, via mechanical connecting-rod and crank systems which are actuated by a reducer with limited play which is moved by an electric motor of suitable power with electronic speed and phase control, for example a brushless motor.

Further characteristic features of the invention and the advantages arising therefrom will emerge more clearly from the following description of a preferred embodiment thereof, illustrated purely by way of a non-limiting example, in the figures of the accompanying plates of drawings in which:

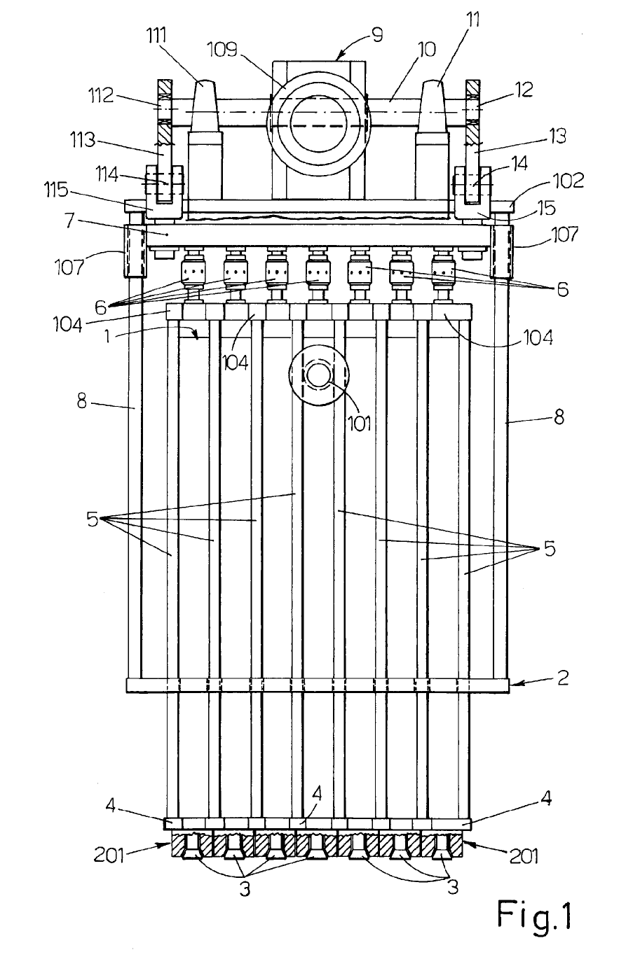

FIG. 1 shows a front elevation view of the apparatus;

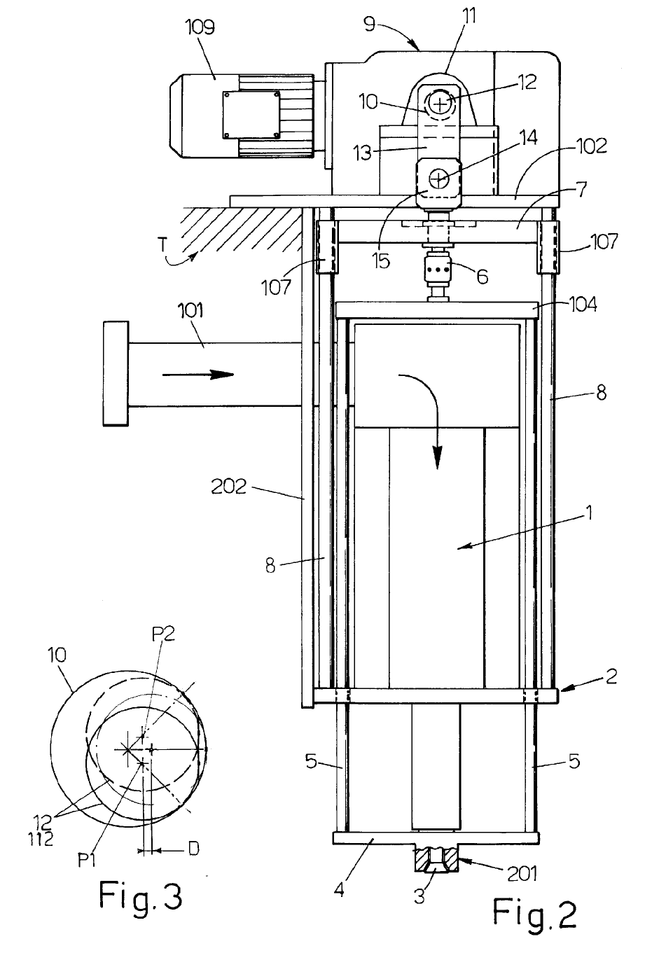

FIG. 2 shows a side elevation view of the apparatus;

FIG. 3 shows a side elevation view, as in FIG. 2, of the details relating to the cranks of the apparatus and their mode of operation;

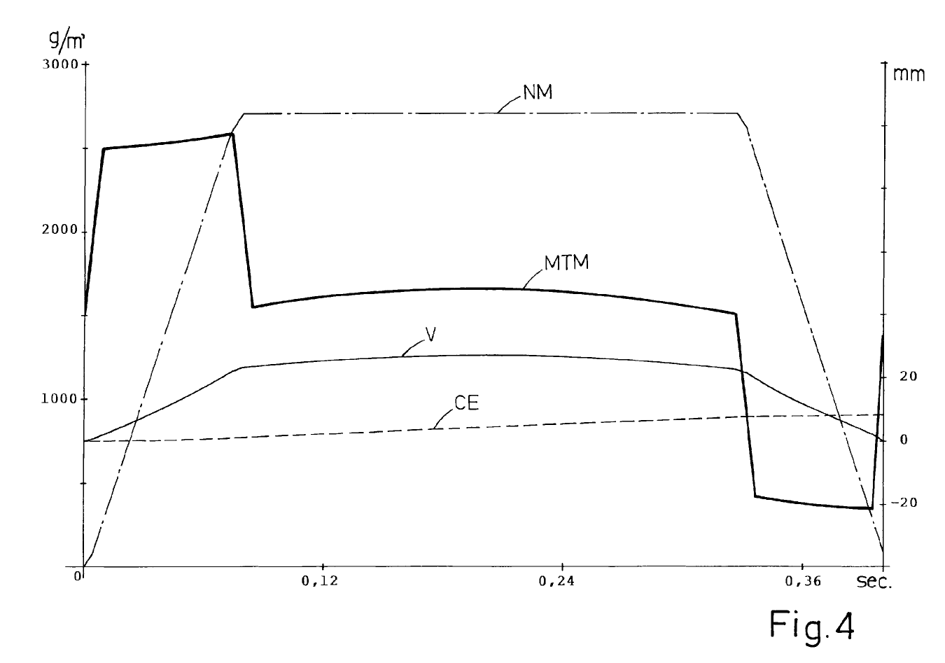

FIG. 4 shows a diagram with the correlated curves for some significant parameters of the actuator in question.

In FIGS. 1 and 2, 1 denotes overall the vertical extrusion head, which is fixed on a support structure 2 supplied by the 90-degree pipe 101 and which discharges the parisons through the bottom mouths 201. In the example in question, the head is of the type where the mouths 201 have the external part movable axially with respect to the associated internal pins 3 which are fixed, so that, in order to modify the cross-section of the parisons leaving the mouths 201, it is necessary to move axially the said mouths which for this purpose are mounted on respective cross-members 4 connected by means of tie-rods 5 to corresponding cross-members 104 situated above the extrusion head 1 and in turn connected by means of corresponding adjustable tie-rods 6 to a common strong cross-member 7 which, as can be seen from the detail in FIG. 2, is provided, at least in the corner zones, with bushes 107 which slide on corresponding vertical guide rods 8 which are fixed at the bottom end to the horizontal structure 2 supporting the head 1 and which at the top end are fixed to a corresponding horizontal structure 102 connected to the said bottom structure 2 by means of a shoulder 202 provided with any suitable means for preferably removable fixing to a support frame T.

According to the invention, the upper support structure 102 has, fixed to it in a middle position, a reducer 9 with limited play, of the type which has a high efficiency and suitable characteristics and the output shaft of which is, for example, hollow and inside the latter the middle part of a shaft 10 parallel to the row of adjustable tie-rods 6 is keyed. The reducer 9 is operated by an electric motor 109 which is preferably of the type with electronic speed and phase control, for example a brushless motor with suitable characteristics. For operation of seven units for regulating corresponding outlet mouths of an extrusion head 1, as in the example according to FIGS. 1 and 2, good results have, for example, been achieved with the use of a reducer 9 with a reduction ratio of between 60 and 70, for example about 63 and with a motor 109 operating at 3000 revolutions and with a torque of about 40-60 Nm.

The shaft 10 is supported rotatably at a short distance from the ends by supports with bearings 11, 111 which are fixed on the support structure 102 and the ends of said shaft are designed with eccentric buttons 12, 112 which have the function of a crank, with suitable eccentricity, for example of about six millimetres, since the maximum axial movement to be imparted to the mouths 201 is less than twelve millimetres and these buttons have, mounted thereon, via bearings with suitable characteristics the ends of corresponding identical connecting rods 13, 113 which are directed downwards and which, with the other end, co-operate via bearings with the pins 14, 114 supported by fork members 15, 115 fixed onto the structure 7 in positions aligned with the adjusters 6, as can be seen from FIG. 2.

It is clear how the rotational movement of the cranks 12, 112 produces, by means of the connecting rods 13, 113, the desired raising or lowering of the structures 7 and 104 with the systems for adjusting the cross-section of the parisons extruded by the head 1. In order to limit the oblique component which the cranks 12, 112 transmit to the moving part to be moved by means of the connecting rods 13, 113, the same cranks are preferably made to operate with an angular displacement within 90 and in such a way that their centre passes from the point P1 to the point P2 and vice versa, such that the horizontal component D of displacement has a limited value.

FIG. 4 shows the various correlated curves relating to the main operating characteristics of the apparatus, where the cycle times are shown in seconds on the x-axis and the speed of rotation of the motor 109 is shown on the y-axis (left-hand side) and the displacement in mm of the vertical stroke for adjusting the outlet cross-section between the parts 201 and 3 is shown on the y-axis (right-hand side). The broken line CE indicates the stroke of the moving part of the apparatus, which is transmitted via the gear motor unit 9, 109 and the system of connecting rods and cranks as described, which stroke is for example in the region of about eight millimetres and takes place in a time period of about forty tenths of a second. The continuous thin line V denotes the speed of movement, the dot-dash line NM indicates the curve for the speed of rotation of the motor 109, while the continuous bold line MTM represents the twisting moment of the said motor 109, which moment has a positive peak during the initial start-up phase of the system and then stabilises at average values during the middle part of the movement and terminates with a peak which is substantially the converse of the initial one.

It is clear how, with an apparatus of the type described, which is low-cost, it is possible to perform movements of small magnitude and with the same force which can be obtained with a hydraulic cylinder and piston system, but without the drawbacks of such a system since the gear motor unit does not require periodic maintenance and because the motor is situated at a distance from the extrusion head and is not directly affected by the heat emitted by it.

It is understood that the scope of the invention also extends to other systems for adjusting the internal cross-section of the outlet mouths of a multiple extrusion head, where means are envisaged for axially moving the pins 3 with respect to the outlet mouths 201 which remain stationary. It is also understood that the description has referred to a preferred embodiment of the invention to which numerous variations and constructional modifications may be made and which may for example relate to the fact that the supports 11, 111 support the shaft 10 at the ends, while the cranks 12, 112 are situated in the middle part of the shaft sections 10 which project from the reducer 9, so that the connecting rods 13, 113 act in intermediate and symmetrical points of the beam 7 for better and more uniform distribution of the flexural forces over the latter. The cranks 12, 112 may be formed in any way different from that illustrated, with the eccentric bushes mounted on the shaft 10 or small lever arms keyed onto the latter. Other variants may refer to the connecting rod and crank systems for raising and lowering the structure 107, which may be supplemented by the use of levers for multiplying the displacement induced by the cranks in order to be able to design the latter with a limited eccentricity and so as to be able to move the connecting rods 13, 113 along substantially straight and vertical trajectories, owing to the greater arm introduced by the said levers. Another variant may for example refer to the fact that the mechanisms 9, 109, 10, 12, 112 with the associated supports 11, 111 may be mounted on a slide which, by means of the action of special adjusting means (not shown), may be displaced on the underlying structure 102 in a direction perpendicular to the shaft 10, in one direction or the other (see FIG. 2), so as to allow the connecting rods 13, 113, depending on the stroke to be performed, to operate with a substantially vertical axis passing inside the space D (FIG. 3). These variants have not be shown in that they may be readily deduced and easily realised by persons skilled in the art.

1. Electrically operated actuator for modifying the thickness of the parisons during extrusion, by means of the usual means which modify the internal cross-section of the outlet mouths of the extrusion head and which are connected to a common cross-member (7) which may be guided by suitable means (107, 8) during the vertical movements, characterized in that the said cross-member is raised and lowered by means of mechanical systems which comprise at least connecting rods and cranks and which are actuated by a speed reducer (9) with limited play and high efficiency, which is fixed onto a support structure (102) positioned above the said cross-member (7) and moved by an electric motor (109) of suitable power, rotating in both directions and with electronic speed and phase control, for example a motor of the brushless type.

2. Actuator according to claim 1, in which the hollow output shaft of the reducer (9) has, keyed thereto, the middle part of a shaft (10) which is parallel to the underlying row of parts to be adjusted and rotatably supported at a short distance from the ends by supports with bearings (11, 111) which are fixed onto the said support structure of the reducer and the ends of the said shaft (10) are provided with eccentric buttons (12, 112) with the function of a crank, with suitable eccentricity, which have, mounted thereon via bearings with suitable characteristics, the ends of corresponding identical connecting rods (13, 113) which are directed downwards and which at their other end co-operate via bearings with pins (14, 114) supported by fork members (15, 115) fixed onto the cross-member (7) connected to the parts to be adjusted.

3. Actuator according to claim 2, characterized in that, according to a constructional variant, the said supports (11, 111) support the movement shaft (10) at the ends, while the cranks (12, 112) are keyed onto the middle part of the sections of this shaft which project from the reducer (9) so that the connecting rods (13, 113) act on intermediate and symmetrical points of the cross-member (7) connected to the parts to be adjusted.

4. Actuator according to claim 3, characterized in that, in order to limit the oblique component which the cranks (12, 112) transmit to the moving part to be moved via the connecting rods (13, 113), the same cranks are preferably operated with an angular displacement (P1-P2) which is within 90 and divided into identical parts above and below a horizontal ideal straight line which intersects the axis of rotation of the shaft (10) with the said cranks.

5. Actuator according to claim 1, in which the connecting rod and crank system may be supplemented by the use of levers for multiplying the displacement induced by the cranks, so as to be able to form the latter with a limited eccentricity and so as to be able to move the connecting rods (13, 113) along trajectories which are substantially straight and vertical, owing to the greater arm introduced by the said levers.

6. Actuator according to claim 1, in which the aforementioned mechanisms (9, 109, 10, 12, 112) and the associated supports (11, 111) may be mounted on a slide which by means of the action of special adjusting means may be displaced on the underlying support structure (102) perpendicularly with respect to the actuating shaft (10) so as to allow the connecting rods (13, 113), depending on the stroke to be performed, to operate with a substantially vertical axis.
